(19) United States
(12) Patent Application Publication
(10) Pub. No.: US 2008/0204363 A1
(43) Pub. Date: Aug. 28, 2008

(54) Display Device

(76) Inventor: Ian Craigie, Brookvale (AU)

Correspondence Address: BROOKS KUSHMAN P.C., 1000 TOWN CENTER, TWENTY-SECOND FLOOR, SOUTHFIELD, MI, 48075, US

(21) Appl. No.: 11/908,890

(22) PCT Filed: Mar. 16, 2006
(86) PCT No.: PCT/AU2006/000340

§ 371 Date: Sep. 17, 2007

(30) Foreign Application Priority Data
Mar. 16, 2005 (AU) 2005901272

(51) Int. Cl. G09G 3/00

(52) U.S. Cl. 345/30

(57) ABSTRACT

The display device consists of a generally flat body member (1) with an attachment-retention element on the rear surface (2), this has three distinct sections, one that attaches the element to the body member (2.1), one that is free from the body member (2.2) and is capable of being bent away from the body member to provide a section to grip a display item (3), and the opposite side of the attachment element (2.3), that which faces away from the body member, that enables the display device to be attached to the support surface (4).

Traditionally photographs are displayed from within photo frames. Conventional photo frames consist of several different components including a frame, a piece of glass or plastic, a backing board or retention device, several clips or pins that hold the whole unit together, and a stand to support it. Placing a photograph in such a frame, or changing the photograph that is on display, can be a difficult and time consuming process.

In addition to this problem is the emerging trend of placing photographs in all manner of location, including kitchens & offices. In such locations the horizontal surfaces are in regular use so photos are often placed on vertical surface. Traditional frames are not well suited to framing photos from vertical surfaces, they are bulky, complicated, have substantial thickness and don't often sit flush with the vertical surfaces in the areas, such as filing cabinets & fridges.

Another problem is that of cost, often a frame consists of several components, each component adds to the cost, the more components the more complex and expensive the frame. In the situation where a photo is to be displayed from a vertical surface the surface can be utilised and eliminate the need for a support stand, the attachment surface becomes the support for the display device. With less components it is cheaper and easier to frame a photo.

With the arrival of the digital age for photography there has been a significant change in how, where & when people take photos. With a digital camera there is virtually no cost involved in taking a photo, a photo is taken and stored electronically. As a result of the lowering of costs people are taking many more photos. In addition to this the cost of printing has become easier & cheaper. In line with this is the need for an inexpensive, simple frame to allow people to quickly & easily display these new photos. Such a device does not need to be limited to displaying photos but can also be used to display a number of other flat items including recipe sheets, safety procedures, kids paintings etc.

The object of the present invention is to provide a display device that overcomes the above mentioned problems to quickly, easily and inexpensively frame a photo, or the like, and to use a simple, inexpensive attachment & retention system that can quickly & simply attach the display device to the support surface and retain the photo within the display device, thus doing away with the need for multiple components and the need for a separate retention system and attachment system to hold the photo in the display device.

The invention provides for A display device comprising of a generally flat body member, with an attachment-retention element on the rear surface of the body member, the body member having a visually transparent section to view a display item, the side of the attachment-retention element that is facing the rear surface of the body member consists of two distinct sections, separated by their function, the first section provides for the attachment of the element to the rear surface of the body member, the second section is not attached to the rear surface of the body member and is able to be bent away from the rear surface of the body member, without detaching the attachment-retention element from the rear surface of the display device, this provides a retention section that grips and retains a display item within the display device, the opposite side of the attachment-retention element, that which is facing away from the body member, enables the display device to attach to a support surface.

To assist with understanding the invention reference will now be made to the accompanying drawings. Illustrations by way of example,

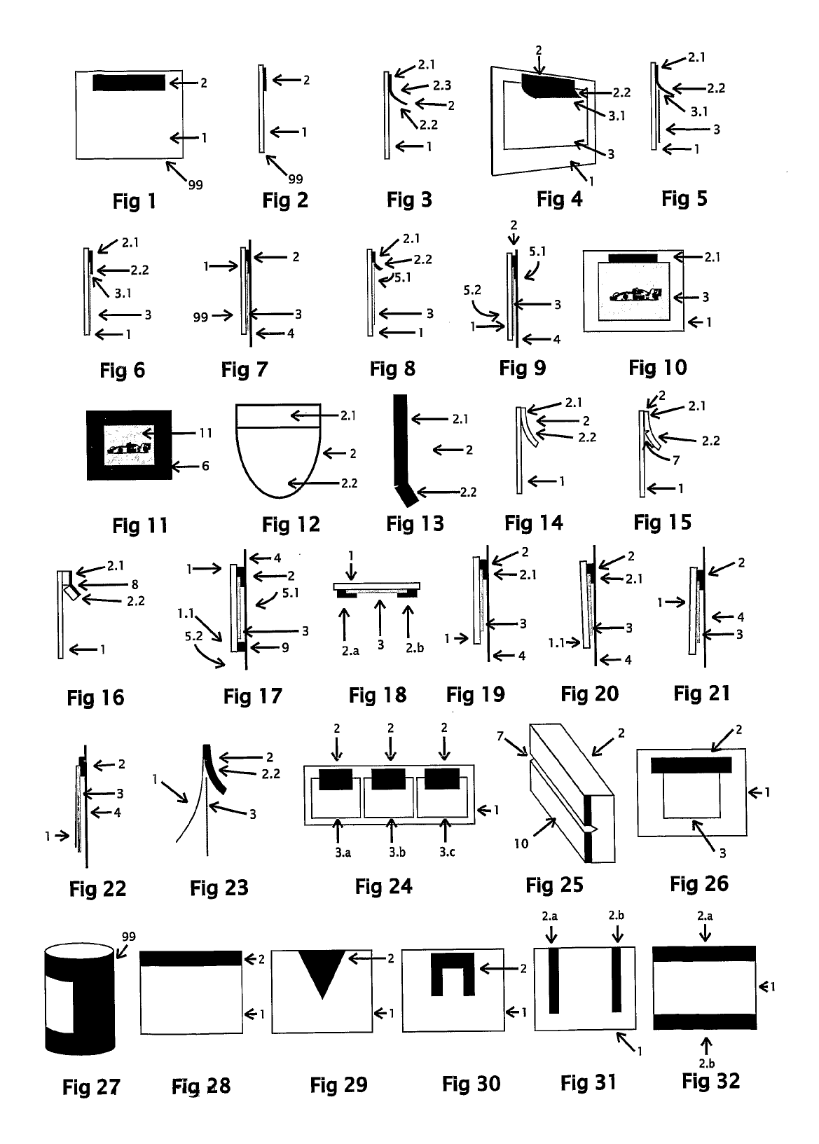

FIG. 1 Is a rear view of the display device (99) with body member (1) & attachment-retention element (2).

FIG. 2 Is a profile view of the display device (99) with Body Member (1) & attachment-retention Element (2).

FIG. 3 Is a profile view of the display device with a portion (2.2) of the attachment-retention element (2) bent away from the rear surface of body member (1), showing the three separate sections of the element (2.1), (2.2) & (2.3)

FIG. 4 Is a rear view of the display device with a photo (3) being placed under the retention section (2.2) of the attachment-retention element (2), (3.1) being where the photo will be gripped by the retention portion (2.2) of the attachment-retention element.

FIG. 5 Is a profile view of a photo (3) being placed under the retention section (2.2) of the attachment-retention element (2).

FIG. 6 Is a profile view of a photo (3) being retained (3.1) under the retention section (2.2) of the attachment-retention element (2) as it returns to its original position. The display item is held in the display device along a portion (3.1) of the display item (3).

FIG. 7 Is a profile view of the display device (99) when attached to a support surface (4)

FIG. 8 Is a profile view of the display device where the retention section (2.2) of the attachment-retention element is starting to grip (5.1) the display item (3).

FIG. 9 Is a profile view of the display device where the body member (1) is applying additional force (5.2) to the display item (3).

FIG. 10 Is a front view of a version of the display device with a clear body member (1) where the attachment portion (2.1) or the attachment-retention element is in view.

FIG. 11 Is a front view of a version of the display device with a masking layer (6) applied to the body member, creating an ascetically pleasing border around a viewing section (11), hiding the attachment-retention element from view.

FIG. 12 Is a rear view of a version of the attachment-retention element (2) where the attachment section (2.1) is rectangular & the retention section (2.2) is triangular.

FIG. 13 Is a profile view of a version of the attachment-retention element (2) where the attachment section (2.1) is longer than retention section (2.2).

FIG. 14 is a profile view of the display device where the retention section (2.2) of the attachment-retention element (2) is being bent away from the surface of the body member (1), the attachment section (2.1) remains attached.

FIG. 15 is a profile view of the display device where the attachment element (2) is constructed with a groove (7) on its surface, helping separate the retention section (2.2) of the attachment-retention element from the attachment section (2.1).

FIG. 16 is a profile view of the display device where the attachment element (2) is hinged by a piece of tape (8) placed across the rear surface of the attachment-retention element (2), allowing the retention section (2.2) of the element to be easily bent away from the surface of the body member (1).

FIG. 17 is a profile view of a version of the display device with an additional attachment element (9) on the body member (1), increasing the gripping force (5.2) exerted by the body member.

FIG. 18 is a profile view of the display device (99) with two attachment-retention elements (2.a) and (2.b) attached to the rear surface of the body member (1).

FIG. 19 is a profile view of a version of the display device with a deformable section (2.1) of the attachment-retention element (2) has been used and where the body member (1) is parallel to the support surface (4).

FIG. 20 is a profile view of a version of the display device with a deformable section (2.1) of the attachment-retention element (2) where the body member (1.1) is angling towards the support surface (4)

FIG. 21 is a profile view of a version of the display device with a non-deformable section (2.1) of the attachment-retention element (2) where the body member (1.1) is angling away from the support surface (4)

FIG. 22 is a profile view with a flexible body member (1).

FIG. 23 is a profile view of a version of the display device with a flexible body member (1) being bent away from the retention section (2.2).

FIG. 24 is a rear view of a version of the device capable of retaining 3 different display items (3.a), (3.b) & (3.c)

FIG. 25 Is a version of the attachment-retention element (2) that has adhesive on its surface (10) and a groove (7) cut in its surface.

FIG. 26 Is a version of the display device where the attachment-retention element (2) is wider than the display item (3) that it is retaining.

FIG. 27 is a version of the display device (99) that is constructed of flexible materials and packaged as a tube.

FIG. 28 is a version of the display device where the attachment-retention element (2) extends the entire length of the body member (1).

FIG. 29 is a version of the display device where the attachment-retention element (2) is triangular.

FIG. 30 is a version of the display device where the attachment-retention element (2) is U shaped.

FIG. 31 is a version of the display device where there are two attachment-retention elements (2.a) and (2.b) consisting of two individual strips extending from the top down, offset from the middle of the display device.

FIG. 32 is a version of the display device where there are two attachment-retention elements (2.a) and (2.b) consisting of two strips running the length of opposite edges of the body panel (1).

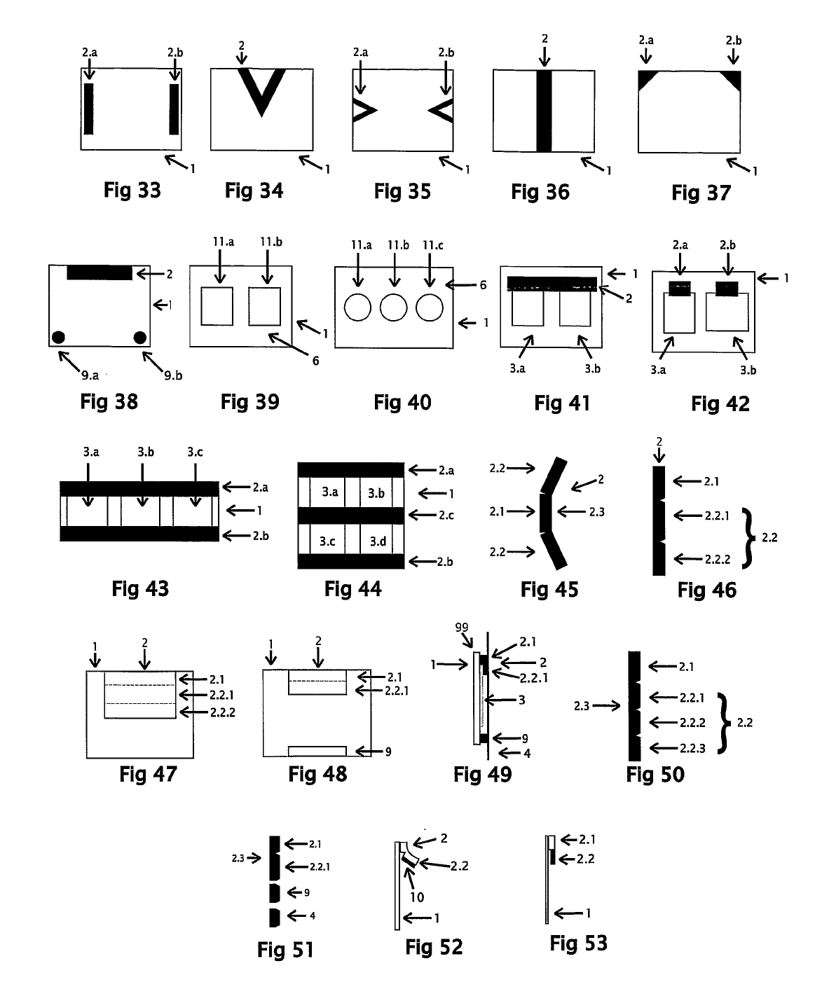

FIG. 33 is a version of the display device where there are two attachment-retention elements (2.a) and (2.b) consisting of two strips running a partial length of the opposite edges of the body panel (1).

FIG. 34 is a version of the display device where the attachment-retention element (2) is V shaped.

FIG. 35 is a version of the display device where there are two attachment-retention elements (2.a) and (2.b) consisting of two V shaped elements on opposite ends of the body panel (1).

FIG. 36 is a version of the display device where the attachment-retention element (2) is a single broad strip extending from the top down, about the middle of the display device.

FIG. 37 is a version of the display device where there are two attachment-retention elements (2.a) and (2.b) in two corners of the body panel (1).

FIG. 38 is a version of the display device where there is one attachment-retention element (2) and two additional attachment elements (9.a) and (9.b) on body panel (1).

FIG. 39 is a version of the display device where the masking layer (6) has been used to create two separate viewing sections (11.a) and (11.b) on the body member (1).

FIG. 40 is a version of the display device where the masking layer (6) has been used to create three separate viewing sections (11.a), (11.b) and (11.c) on the body member (1).

FIG. 41 is a version of the display device where a single attachment-retention element (2) is used to grip & hold two separate display items (3.a) and (3.b).

FIG. 42 is a version of the display device where two attachment-retention elements (2a) and (2.b) are used to grip and hold two separate display items (3.a) and (3.b).

FIG. 43 is a version of the display device where two attachment-retention elements (2.a) and (2.b) are used to grip and hold three separate display items (3.a) (3.b) and (3.c).

FIG. 44 is a version of the display device where three attachment-retention elements (2.a), (2.b) and (2.c) are used to grip and hold four separate display items (3.a), (3.b), (3.c) and (3.d).

FIG. 45 shows a profile view of a version of the attachment-retention element (2) that has two separate retention sections (2.1) and is able to grip two separate display items.

FIG. 46 shows a profile view of a version of the attachment-retention element (2) that has on one side three separate sections (2.1), (2.2.1) and (2.2.2), the retention section (2.2) is split into two distinct sections, (2.2.1) and (2.2.2), this latter section (2.2.2) can be detached and become an additional attachment element (9).

FIG. 47 shows rear view of a version of the attachment-retention element (2) attached to the body member (1) and there are three separate sections (2.1), (2.2.1) and (2.2.2), the retention section (2.2) is split into two distinct sections, (2.2.1) and (2.2.2), this lower section (2.2.2) can be detached and become an additional attachment element (9).

FIG. 48 shows a version where the section (2.2.1) has been removed from the attachment-retention element and attached to the body member (1) to become an additional attachment element (9).

FIG. 49 shows a profile view where the section (2.2.1) has been removed from the attachment-retention element and attached to the body member (1) to become an additional attachment element (9), when attached to a suitable support surface (4).

FIG. 50 shows a profile view of a version of the attachment-retention element (2) that has three grooves in its surface, defining 4 distinct sections on one side, sections (2.1), (2.2.1), (2.2.2) and (2.2.3), the retention section (2.2) is split into three distinct sections, (2.2.1), (2.2.2) and (2.2.3), the two latter sections (2.2.2) ad (2.2.3) can be detached and become an additional either or both, attachment element (9) and support surface (4).

FIG. 51 shows how once detached the components can be used as either or both, additional attachment element (9) and support surface (4).

FIG. 52 is a profile view of a version of the display device where an adhesive (10) has been applied to the surface of the retention section (2.1) of the attachment-retention element (2).

FIG. 53 is a profile view of a version of the attachment-retention element (2) where the attachment section (2.1) is of greater thickness than the retention section (2.2).

The following legend applies to the accompanying figures.
1—Body Member
   1.1 End of the display device furthest from the attachment-retention element (2)
2—Attachment-Retention element
   2.1—Portion of the element that is attached to the body member.
   2.2—Portion of the element that holds the display item in position.
      2.2.1 portion of retention section of attachment-retention element
      2.2.2 portion of retention section of attachment-retention element
      2.2.3 portion of retention section of attachment-retention element
   2.3—Portion of the element that attaches to the support surface.
   2.a Attachment-retention element 1
   2.b Attachment-retention element 2
   2.c Attachment-retention element 3
3—Display Item
   3.1 Section of display item that is gripped by the retention portion (2.2) of the attachment-retention element (2)
   3.a Display Item 1
   3.b Display Item 2
   3.c Display Item 3
   3.d Display Item 4
4—Support Surface
5—Gripping Forces
   5.1 Direction of force from retention section (2.2) of the attachment-retention element.
   5.2 Direction of force from body member (1)
6—Masking Layer
7—Groove in surface of attachment-retention element (2)
8—Tape creating hinge for attachment element
9—Additional Attachment Element
   9.1 Additional attachment element 1
   9.2 Additional attachment element 2
10—Adhesive on the surface of the attachment-retention element (2).
11—Viewing Section
   11.a viewing section 1
   11.b viewing section 2
   11.c viewing section 3
99—The Display Device

Referring to the drawings FIG. 1 shows a rear view of the display device (99) consisting of a clear body member (1) and attachment/retention element (2). FIG. 2 shows the same display device (99) in profile.

FIG. 3 shows the device in profile with the attachment-retention element (2) being bent away from the surface of the body member (1). This shows the three distinct sections of the attachment-retention element (2), The section (2.1) of the element that is attached to the body member, the section (2.2) of the element that can be bent away from the surface of the display device (1) to accommodate and hold the display item (3) in position within the display device, and the section (2.3) of the element that attaches the display device to the support surface.

FIG. 4 shows that to display an item (3) from the device, such as a photo, it is placed on the rear surface of the body member (1), the element (2) is bent away from the body member at section (2.2) to allow a portion of the display item (3.1) to be placed between the uplifted edge of the element (2.2) and the body member (1). FIG. 5 shows that the photo can then be slid up to the section of the element (2) that is attached to the body member (2.1). In a preferred embodiment FIG. 4 this point of abutment will run the length of the element (2) and allow for the fast and accurate placement of the display item within the display device, under the section (2.2) of the attachment-retention element.

Once the photo has been place within the device, FIG. 6 the retention section (2.2) of the attachment-retention element (2) can be lowered, retaining the display item, by gripping the edge of the display item (3.1), and holding it between the body member (1) and the retention section (2.2) of the element (2). It should be noted that if the display item (3) is light weight, such as a photograph, the section (2.2) of the attachment-retention element that is required to retain the display item can then be small.

There are significant cost savings from having a single element able to do two different functions, there are cost savings in both materials & in assembly. A single element speeds up the manufacturing process & the process of putting the display device to use.

FIG. 7 shows the display device and display item can be easily attached to a suitable support surface, such as a vertical or near vertical surface. The rear-facing section (2.3) of the attachment-retention element can attach to the support surface, it holds the display device in place, while the display item (3) is held in place, by a gripping pressure, between the body member (1) and the retention section (2.2) of the attachment-retention element. The gripping pressure that holds the display item in place is created by two different forces (5.1) and (5.2). FIG. 8 shows that as the element (2) moves towards its original flat configuration it traps the display item (3) between the body member (1) and the retention section (2.2) of element (2), (5.1) indicates the direction of the force being applied. FIG. 9 shows that when the display device is attached to a support surface the element (2) is forced towards being flat, applying more gripping force (5.1) to the display item. In addition to this the body member (1) also pushes down (5.2), by virtue of its weight, on the photo (3.1) pushing it against the retention section (2.2) of the element (2), this force is created by the weight of the body member being levered off section (2.1) of the element. It should be noted that a display item such as a photo, or a sheet of paper, is both light and thin so the forces that are required to hold such an object in place are small. The smaller the force required, the smaller the attachment-retention element that is needed. These forces will act to grip a photo on a support surface; no matter what angle the display device is attached to the support surface, accommodating a support surface from vertical to horizontal. For a common 15 cm×10 cm photo a small attachment/retention element is all that is required.

The display device is a single unit, in one piece; no separate attachment component is required to generate the gripping force (5.1). Upon attachment to a support surface the gripping is force of (5.1) is increased and the additional gripping force of (5.2) is created.

When displaying a photo FIG. 7, a thin, flat attachment-retention element (2) is preferred, because the smaller the gap between the body member (1) and the support surface (4) the flatter the photo will remain, lessening the likelihood that it will curl up over time. The two sections (2.1) & (2.2) of the attachment-retention element (2) can be the same thickness or of different thickness.

The gripping affect is not released until the display device is removed from the support surface, (or the body member is bent away from the support surface FIG. 22). While the device is attached to the support surface, and the body member (1) remains flat, the retention section (2.1) of the attachment-retention element cannot release the display item and the gripping forces (5.1) & (5.2) are maintained. When the device is removed from the support surface (4) the retention portion of the element is free to swing away from the body member and release the display item.

The body member of the display device is required to be generally flat with a visually transparent section that enables the viewing of the item that is on display within the device. The body can be made of different materials, these may include rigid, semi-rigid, resilient, flexible, malleable, deformable, bendable, conformable & flexible materials or any combination of these properties. The body member can be made of transparent material or it can be made of non-transparent material with a viewing section created, or cut, to allow viewing of the display item. The body member can be constructed of a number of different materials including glass, plastic, rubber, resin, wood etc or a combination of these materials. A preferred embodiment would have the body member made of clear plastic of approximately 1 mm thickness.

The body member can be made of any shape as long as it is generally flat. Traditionally photo frames have been rectangular, with this device the photo frame can easily be created in any range of different shapes. It should be noted that a flat body member that is created from can be used to display items from non-flat surfaces, such as a curved fridge door, being flexible, the body member (1) and attachment-retention element (2) can flex and conform to the shape of the support surface.

When the body member (1) is made of a clear transparent material FIG. 10 a masking effect (6) applied to a portion of the body member (1), this can be applied around the perimeter of the viewing section (11), to hide the element (2) from view FIG. 11. A masking effect can significantly enhance the function of the display device when displaying a photo by improving the look & aesthetics of the device. A masking effect can be created in a number of different ways including adding a separate masking component, by painting, screen printing, etching, adhesive film, adhesive tape or engraving a layer onto the body member, or any combination of these. In a preferred embodiment the masking element would be painted onto the body member to create a framing effect around the viewing portion of the body member. A masking layer can be used to produce one, or many separate viewing sections (11) on the body member (1). The body member can have a mask applied to create a single viewing section (11) FIG. 11, or two viewing sections (11a) and (11b) FIG. 39, or three (11a), (11b) and (11c) FIG. 40, or as many as are required. When used as a photo frame the display device (99) can use multiple viewing sections (11) to display multiple photos (3)

The attachment-retention element (2) on the rear surface of the body member can be any shape as long as it can preform its functions of one, having a portion (2.1) attaching to the body member and two, having a portion of the non-attached section of the element (2.2) able to be lifted, swung or temporarily moved away from the surface of the body member (1) to accommodate a display item (3) that can be gripped between the retention part of the element (2.2) and the body member (1) and three, having the rear surface (2.3) able to attach the display device to a suitable support surface.

In one embodiment FIG. 1 of the element (2) the attachment section (2.1) can be rectangular and flat. In another embodiment FIG. 12 of the element (2) the attachment section (2.1) can be long and flat and the retention section (2.2) can be triangular to create a large surface area to grip the display item. In another embodiment FIG. 13 the element (2) the attachment section (2.1) can be long and the retention section (2.2) can be relatively short. In a preferred embodiment the element (2) would be generally flat, rectangular and approximately 1 mm thick.

The attachment element can be constructed of any material, or combination of materials such that it is capable of performing its three required functions. The element can be made of different material and these may include rigid, semi-rigid, resilient, flexible, malleable, deformable, bendable, conformable or any combination of these. The element can be made of plastic, rubber, foam, sticky polymers (eg fix-max), magnet, hook fasteners, loop fasteners, metal, adhesive or any combination of these materials. In a preferred embodiment the element (2) would be made of magnet impregnated plastic strip, an adhesive is used to attach the attachment portion (2.1) of the element to the body member, being deformable it can easily have a portion (2.2) bent or swung away from the body member (1) to accommodate a photo (3), being magnetic the element is able to attach to a support surface such as a filing cabinet door or fridge door.

To function as required the element (2) on the rear surface of the body member can be constructed in a number of different ways. In a one version FIG. 14 it can be made of a bendable material where a section can be easily bent away from the surface of the body member, the more flexible the material the more easily this can be achieved. In another FIG. 15 version the element (2) can be constructed with a groove upon its surface (7), this groove will help identify the two separate sections (2.1) & (2.2) of the attachment-retention element, and facilitate the ease of bending the element away from the body member (1). A small groove in the surface will enhance the ability of the attachment-retention element (2.1) to both attach to the body member (1) and to have the retention section of the element (2.2) bent away from the body member. In a version FIG. 16 where a non-flexible materials are used the element can be constructed to hinge along the line that separates the two sections (2.1) & (2.2) of the element. Hinging can be achieved as simply as placing a piece of adhesive coated tape (8) along the rear surface of the two sections. A resilient tape would be useful as it would tend to return to flat after being bent.

A resilient attachment-retention element (2) is useful as it will increase the grip force (5.1) that is placed on the display item, having a generally flat attachment-retention element made of a resilient material will mean that the element, after being bent to insert a display item will tend to return to its original flat configuration and in doing so further grip the display item (3).

The thickness of the two different sections (2.1) & (2.2) of the attachment-retention element (2) can be different. Having the retention section (2.2) slightly thinner than the attachment section (2.1) you can more easily accommodate a display item (3) and keep the display device (99) parallel to the support surface FIG. 19. If you know the thickness of the display item (3), you can reduce the thickness of the attachment section (2.2) of the attachment-retention element by this amount, or slightly less, to more easily accommodate a display item. In a version of the device FIG. 19 there is a rebate running along the length of the attachment-retention element that defines the retention section (2.2).

To further reduce the cost of the device (99) it can be provided in kit form, where the user needs to assemble the device. This is no difficult as it can be made as simple as sticking a stamp onto an envelope, in this case the attachment-retention element (2) would need to be attached to the body member (1) by the user. By having an adhesive on the surface of the attachment retention element it can easily be attached to the body member (1) along the section of the element (2.1) by the user.

In another embodiment FIG. 17 an additional attachment element (9) can be place on the body member to provide greater grip (5.2) on the display item (3) by increasing the leverage force created by the body member. The greater the distance (1.1) this additional element (9) is placed from the first element (2) the greater the resultant leverage and grip force (5.2) on the photo. For example where the attachment-retention element (2) contains a magnetic material, to allow it to attach to a suitable metallic surface, such as a fridge, an additional piece of magnetic material (9) can be placed on the body member to enhance the grip force (5.2) on the display item (3).

In another embodiment FIG. 18 two attachment & retention elements (2) can be placed on the rear surface of the body member (1), the further apart they are placed the greater the resultant gripping force (5.2) on the display item (3). Such an embodiment would be useful with a wide display item, such as a panoramic photo. Rather than have one long attachment-retention element (2) running the entire length of the body member (1), two smaller attachment-retention elements (2.a) and (2.b) could be used to grip the item at each end, with an overall saving in materials.

The choice of physical properties of the materials used to construct the attachment-retention element (2) can be utilised to create a range of specific additional benefits, which would be useful in different situations. In the situation where a deformable (or rebated) material is used FIG. 19 to create the retention section (2.2) of the attachment-retention element (2) the display device can be easily quickly placed parallel to the support surface, alternatively if the whole element is made of a deformable material FIG. 20 the end of the display device (1.1) opposite the attachment-retention element can be made to angle in towards the support surface (4), this would be useful when the display device is set high and people need to look up towards it. In the situation where a non-deformable material is used FIG. 21 to create the retention section (2.2) of the attachment-retention element (2) the display device can made to angle away from the support surface (4), this would be useful when the display device is set low and people need to look down towards it. In another embodiment FIG. 22 the body member can be made of a flexible or deformable material, it would accommodate the display item and allow the body member (1) to be lifted FIG. 23 away from the support surface (4) to aid in the removal or insertion of a display item.

A rebate can be created on section (2.1) of the attachment-retention element to assist having the body member (1) remain parallel FIG. 19, to the support surface (4), or to lean in towards the support surface (4), when attached FIG. 20.

In another embodiment FIG. 52 of the invention the retention portion (2.2) of the attachment & retention element (2) can be provided with an adhesive on its surface (10), the addition of an adhesive will aid in the gripping of the display item. This would be useful in a version of the display device that was designed to hold more than one photo, FIG. 24, all the photos could be lightly held in place before being place on the support surface. For example a low tack adhesive can be used to help position and hold the photo in place before the display device is attached to the support surface. As we only have two hands any more than two display items would be difficult to place and hold at the same time without this.

In another version of the display device it can be produced with an adhesive upon the surface of the attachment-retention element (2.2) that faces the body member (1), this can be provided with a removable protective cover sheet, the attachment-retention element (2) will still function while this cover sheet is in place as it will still grip (5.1) the display item (3.1). The user can choose to remove the cover sheet and have the adhesive assist in holding the photo in place during placement before the gripping force (5.1) and (5.2) hold the photo in place.

FIG. 25 shows a version of the attachment-retention element (2) that has a groove (7) created in its surface and an adhesive (10) upon its surface.

FIG. 26 shows a version of the display device where the attachment-retention element (2) is wider than the display item (3), this has the benefit of providing protection to the display item, the display item is protected from dust & liquids being spilt or settling upon it from above. In the situation where the display device is used to display a photo from a fridge, the top of the photo is protected, by the attachment-retention element (2), from splashes in the kitchen, the front is protected by the body member (1).

FIG. 27 shows a version of the display device where the body member (1) and attachment-retention element (2) are constructed of a flexible material, being flexible the display device (99) can be packaged in a non-flat configuration, such as a tube, when unpacked it can be returned to its generally flat construction to function as a display device. Another benefit of using flexible materials is that it can be used to display a photo from a non-flat surface such as curved fridge door, as the display device conforms to the curve of the support surface. Such an embodiment would be useful for a promotional product.

There are a number of different configurations and placement of the attachment-retention element (2) to fit within the scope of this invention. Outlined here are some by way of example.

FIG. 28 shows a version of the display device where the attachment-retention element (2) runs the length of the body member (1).

FIG. 29 shows a version of the display device where the attachment-retention element (2) is triangular.

FIG. 30 shows a version of the display device where the attachment-retention element (2) is U shaped.

FIG. 31 shows a version of the display device where the attachment-retention element (2) consists of two strips (2.a) and (2.b) around the centre of the body member (1).

FIG. 32 shows a version of the display device where the attachment-retention element (2) consists of two strips (2.a) and (2.b) running along two parallel edges of the body member (1).

FIG. 33 shows a version of the display device where the attachment-retention element (2) consists of two strips (2.a) and (2.b) running partway along two parallel edges of the body member (1).

FIG. 34 shows a version of the display device where the attachment-retention element (2) is V shaped.

FIG. 35 shows a version of the display device where the attachment-retention element (2) consists of two V shaped strips (2.a) and (2.b).

FIG. 36 shows a version of the display device where the attachment-retention element (2) consists of a single strip placed in the middle of the body member (1) running top to bottom.

FIG. 37 shows a version of the display device with two attachment-retention elements (2) that are triangular in shape and placed in the corners of the body member (1).

FIG. 38 shows a version of the display device with a single attachment-retention element (2) and two separate, additional attachment elements (9.a) and (9.b) on the rear surface of the body member (1).

FIG. 39 shows a version of the body panel (1) where a masking layer (6) has been used to create two viewing sections (11.a) and (11.b).

FIG. 40 shows a version of the body panel (1) where a masking layer (6) has been used to create three viewing sections (11.a), (11.b) and (11.c).

FIG. 41 shows a version of the display device (99) where a single attachment-retention element (2) is used to retain two separate display items (3.a) and (3.b).

FIG. 42 shows a version of the display device (99) where two attachment-retention elements (2a) and (2.b) are used to retain two separate display items (3.a) and (3.b).

FIG. 43 shows a version of the display device (99) where two attachment-retention elements (2a) and (2.b) are used to retain three separate display items (3.a), (3.b) and (3.c).

FIG. 44 Shows a version of the display device (99) where there are three attachment-retention element (2a), (2.b) and (2.c) that are used to retain four separate display items (3.a), (3.b), (3.c) and (3.d).

The above illustrations show that with in the scope of the invention there are a number of different configurations possible for the attachment-retention element (2), its shape, its position and the number of separate elements that can be used. A single attachment-retention element, FIG. 1, can be used to grip, hold & retain one, FIG. 10, or multiple separate display items FIG. 41. Alternatively multiple attachment-retention elements can be used to grip, hold & retain one, FIG. 18, or multiple separate display items, FIG. 42, FIG. 43, FIG. 44.

The grip forces (5.1) and (5.2) created by the attachment-retention element (2) and body member (1) can be further increased by the addition of separate attachment elements (9), one or more of these can be placed on the rear surface of the body member (1), FIG. 17, FIG. 38. The further (1.1) from the attachment-retention element (2) the greater the gripping force (5.2).

A masking layer can be used effectively to create a single viewing section FIG. 11 or multiple viewing sections, FIG. 39, FIG. 40, on the same body member (1), allowing one or more separate display items to be retained and displayed from within the display device (99), FIG. 24, FIG. 41, FIG. 42, FIG. 43, FIG. 44.

The attachment-retention element (2) can be created in a number of different ways, maintaining the scope of this invention. FIG. 41 shows that one attachment-retention element (2) can hold two separate display items (3), FIG. 18 shows that two attachment-retention elements (2) can hold a single display item (3). FIG. 44 shows a version where a single attachment-retention element (2c) grips the display items above & below (or side by side if rotated), in a version such as this the attachment-retention element (2c) needs to be constructed so that is has two distinct retention sections, these are required to be able to hold a display item either side of the attachment section (2.1). FIG. 45 shows a version of the attachment-retention element (2), where there are two separate retention sections (2.2.1) and (2.2.2) either side of the attachment section (2.1). Such a construction allows the element to simultaneously grip adjacent display items. This is especially useful in for a version of the display device as shown in FIG. 44, where display items are next to each other, or above and below one another.

Additional variations of the attachment-retention element (2) are possible; FIG. 18 shows a version where a groove has been created in the surface of the attachment-retention element (2) to help with the bending of the element and in defining the different sections (2.1) and (2.2) of the attachment-retention element (2). An additional groove may be cut in the surface of the attachment-retention element (2), without affecting its ability to function as required, and thus dividing the retention section (2.2) into two areas (2.2.1) and (2.2.2) FIG. 46. FIG. 47 shows an attachment-retention element (2) with two grooves and three distinct sections (2.1) and (2.2.1) and (2.2.2) when attached to a body member (1).

In use, as shown in FIG. 48 the section (2.2.2) can be removed from the attachment-retention element (2) by the user, leaving section (2.2.1), without affecting the ability of the attachment-retention element (2) to function, when removed the section that was (2.2.2) becomes a separate component that can be reattached to the body member (1), by the user, to now function as an additional attachment element (9). It is noted that the display device will function whether or not the section (2.2.2) has been removed. In practice this is achieved in a version of the display device where the surface of the attachment-retention element (2) has an adhesive (10) on its surface, that which faces the body member, and the adhesive is covered with a protective release sheet. If the user chooses to remove the section (2.2.2) of the attachment-retention element, the device still functions, and the component that was (2.2.2) can have the release sheet removed, and using the adhesive it can be stuck on the surface of the body member (1), around (1.1) to become an additional attachment element (9) for the display device (99).

A further development of the concept can have the attachment-retention element (2) produced with 3 grooves (or even more), creating 4 distinct sections on the attachment-retention element (2), FIG. 50. In this version of the display device the bottom two sections (2.2.2) and (2.2.3) can be removed from the attachment-retention element (2) by the user, these become two separate components, one of these can be attached to the body member to become an additional attachment element (9), the other can be used to create a suitable attachment surface (4), the adhesive will allow the component to be attached to a flat surface (not just metal), the magnetic material will make it suitable for the attachment section (2.3) the display device (99) to be attracted, attach and hold on to the support surface (4). Such an embodiment allows for a very inexpensive, simple and very useful display device, one that can be easily and quickly adapted to display a photo or display item, or items, from a variety of different support surfaces. There is no limit on the number of grooves and thus additional attachment elements (9), or support elements (4) that can be created by this method.

In a practical sense the use of a magnetic material, with an adhesive, allows the display device to be attached to many types of surfaces, anything a magnet or an adhesive will stick to is now capable of becoming a suitable support surface (eg metal, glass, plastic, paint, wood, etc) in fact at least one surface in almost (possibly) every home or office. The combination of grooves, adhesive and a release sheet on the attachment-retention element offer a number of advantages, in manufacture; the device can be created in kit form, where assembly is fast and simple, peel the release sheet, and break off the components you need for attaching the display device and put the together. Alternatively the element can come already attached to the body member, it would then comes as a single unit and the user can remove and convert the additional components as required, if using the display device to display a photo from a metal type surface nothing needs to be done, if another surface is chosen, such as a painted wall, the required components can be removed from the attachment-retention element (2) as required and converted into additional attachment elements (9) or support elements (4).

1. A display device comprising of a generally flat body member, with an attachment-retention element on the rear surface of the body member, the body member having a visually transparent section to view a display item, the side of the attachment-retention element that is facing the rear surface of the body member consists of two distinct sections, separated by their function, the first section provides for the attachment of the element to the rear surface of the body member, the second section is not attached to the rear surface of the body member and is able to be bent away from the rear surface of the body member, without detaching the attachment-retention element from the rear surface of the display device, this provides a retention section that grips and retains a display item within the display device, the opposite side of the attachment-retention element, that which is facing away from the body member, enables the display device to attach to a support surface.

2. A display device according to claim 1 wherein there are multiple attachment-retention elements on the rear surface of the body member.

3. A display device according to claim 1 wherein the attachment section of the attachment-retention elements is of a different thickness to that of the retention section.

4. A display device according to claim 1 wherein the elements are constructed of a flexible magnetic material.

5. A display device according to claim 1 wherein a masking layer is applied to a portion on the body member.

6. A display device according to claim 2 wherein the attachment section of the attachment-retention elements is of a different thickness to that of the retention section.

7. A display device according to claim 2 wherein the elements are constructed of a flexible magnetic material.

8. A display device according to claim 3 wherein the elements are constructed of a flexible magnetic material.

9. A display device according to any claim 2 wherein a masking layer is applied to a portion on the body member.

10. A display device according to claim 3 wherein a masking layer is applied to a portion on the body member.

11. A display device according to claim 4 wherein a masking layer is applied to a portion on the body member.
